(19) United States
(12) Patent Application Publication
(10) Pub. No.: US 2025/0173331 A1
(43) Pub. Date: May 29, 2025

(54) GENERATING STRUCTURED DATA FOR MIXED REALITY APPLICATIONS USING GENERATIVE ARTIFICIAL INTELLIGENCE

(71) Applicant: simpleAR, Inc., Irvine, CA (US)

(72) Inventors: Julian Volyn, Long Valley, NJ (US); Michael Davis, Yorba Linda, CA (US); TJ Southard, Newport, NC (US); Phillip Do, Chandler, AZ (US); Josh Zavaleta, Aliso Viejo, CA (US); James Williams, Anaheim, CA (US); Marlo Brooke, Newport Coast, CA (US); Scott Toppel, Virginia Beach, VA (US)

(21) Appl. No.: 18/584,751

(22) Filed: Feb. 22, 2024

Related U.S. Application Data
(60) Provisional application No. 63/603,040, filed on Nov. 27, 2023.

(51) Int. Cl. G06F 16/2452

(52) U.S. Cl. CPC G06F 16/24522

(57) ABSTRACT

Systems and methods for generating structured data for mixed reality applications using generative artificial intelligence are disclosed. Unstructured data including instructional content is received. A schema to which the unstructured data is to conform is established. Then, a system task prompt based on the unstructured instructional content and the schema input is established. The system task prompt is provided to a generative artificial intelligence model. Structured data is received from the generative artificial intelligence model. A procedure usable in a mixed reality application is constructed using the structured data.

### CROSS-REFERENCE TO RELATED APPLICATION

This application claims the benefit of provisional U.S. Application No. 63/603,040, filed on Nov. 27, 2023, and entitled “GENERATING STRUCTURED DATA FOR MIXED REALITY APPLICATIONS USING GENERATIVE ARTIFICIAL INTELLIGENCE” which is hereby incorporated by reference in its entirety.

In cases where the present application conflicts with a document incorporated by reference, the present application controls.

### BACKGROUND

Instruction manuals, instructional videos, and other instructional content is typically stored as unstructured data. Unstructured data may include various data types. For example, a digital instruction manual may include various combinations of text, photographs, videos, diagrams, etc.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram that describes data exchange in accordance with the facility.

FIG. 3 is a flow diagram showing a process used by the facility in some embodiments to generate structured data for use in mixed reality applications.

FIG. 4 is a display diagram illustrating an interface used by the facility in some embodiments to receive unstructured data including instructional content.

FIG. 5 is a document diagram showing an example excerpt of unstructured instructional content accessed by the facility in some embodiments.

FIG. 6 is a flow diagram showing a process performed by the facility in some embodiments to generate structured data in response to a submitted system prompt including preliminary input and supplemental input.

FIG. 7 is a display diagram illustrating an interface used by the facility in some embodiments to receive one or more preliminary commands.

FIG. 8 is a display diagram illustrating an interface used by the facility in some embodiments to display proposed structured data generated by a large language model in response to a submitted system prompt including one or more preliminary commands.

FIG. 9 is a display diagram illustrating an interface used by the facility in some embodiments to display updated proposed structured data generated by a large language model using proposed structured data and supplemental commands.

FIG. 10 is a flow diagram showing a process performed by the facility in some embodiments to respond to a viewer query based on generated structured data.

### DETAILED DESCRIPTION

The inventors have recognized that because unstructured documents may not follow a consistent schema, it may be difficult to extract structured data following a specified schema from them. But it is often desirable to extract structured data following a specified schema from unstructured data. For example, unstructured data of an instruction manual may be converted into structured data including a series of steps for a user to perform in a mixed reality application. Extracting structured data from unstructured data is often done manually or using expensive traditional data extraction techniques. These traditional methods may introduce errors, take a significant amount of time, require significant computation, or limit the amount of structured data that may be produced for use in mixed reality (MR) applications.

Modern computing and display technologies have facilitated the development of systems for so called “virtual reality” or “augmented reality” experiences, in which digitally reproduced images or portions thereof are presented to a user in a manner that simulates interaction with the physical world. A virtual reality, or “VR”, scenario typically involves the presentation of digital or virtual image information without transparency to other actual real-world visual input; an augmented reality, or “AR”, scenario typically involves presentation of digital or virtual image information as an augmentation to visualization of the actual world around the user. A mixed reality, or “MR”, scenario is a type of AR scenario and typically involves virtual objects (artifacts) that are integrated into, and responsive to, the natural world. For example, in an MR scenario, a virtual artifact may be occluded by real world objects and/or be perceived as interacting with other objects (virtual or real) in the real world. Throughout this disclosure, reference to AR, VR or MR is not limiting on the invention and the techniques may be applied to any context.

Furthermore, innovations in machine learning technology have facilitated the development of generative artificial intelligence models including large language models (LLMs) such as generative pre-trained transformer (GPT) 3, 3.5 and 4, generative adversarial networks, recurrent neural networks, reinforcement learning models, variational autoencoders, etc. In general, a generative artificial intelligence model is trained to generate content in response to a prompt.

LLMs like GPT 4 operate on natural language and may be capable of generating output responsive to a variety of prompts, including prompts specifying a format for the output to follow. For example, an LLM may take as input a natural language prompt such as “write a haiku about birds.” The LLM may then produce as output a natural language haiku about birds.

The inventors have recognized that it may be useful to generate structured data for use in mixed reality applications from unstructured data using a large language model. For example, it may be helpful to extract a sequence of steps from an instruction manual and use the sequence of steps to construct a mixed reality instructional application based on the steps.

The inventors have further recognized that conventional techniques for extracting structured data from unstructured data for use in mixed reality applications limit the feasibility of creating mixed reality applications. In particular, they have recognized that development of mixed reality applications based on unstructured documents is hindered by the reliance of conventional techniques on manual data extraction.

In response to recognizing these disadvantages, the inventors have conceived and reduced to practice a software and/or hardware facility for generating structured data for mixed reality applications using generative artificial intelligence (“the facility”).

The facility receives unstructured instructional content, such as an instructional manual or other forms of unstructured instructional content. The facility also receives input specifying a first schema to which the unstructured instructional content is to conform. The facility creates a system task prompt based on the unstructured instructional content and the input. Then, the facility submits the system task prompt to a generative artificial intelligence model. The facility receives proposed structured data from the generative artificial intelligence model and parses the proposed structured data according to the first schema. In some embodiments, in response to successfully parsing the proposed structured data, the facility converts the proposed structured data to conform to a second schema usable in mixed reality applications. Text associated with a discrete step in a mixed reality application may be displayed using the mixed reality experience. Other information associated with the step may also be displayed, such as pictures, videos, etc. For example, in a mixed reality experience instructing a user how to assemble a drone, text instructing the user to perform an assembly step may be displayed, or the text may be provided in speech via text-to-speech. Video, pictures, etc., instructing the user how to perform the assembly step may also be displayed.

By performing in some or all of the ways described above, the facility automatically generates structured data for use in mixed reality applications based on unstructured data, saving human effort and improving the ultimate quality of the mixed reality applications. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by automatically generating the structured data, the facility obviates the use of processing resources to display and service a user interface for creating and editing manually generated structured data. By using a generative artificial intelligence model to extract structured data from unstructured data, the facility avoids traditional computationally expensive techniques for extracting structured data from unstructured data such as various image processing techniques.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

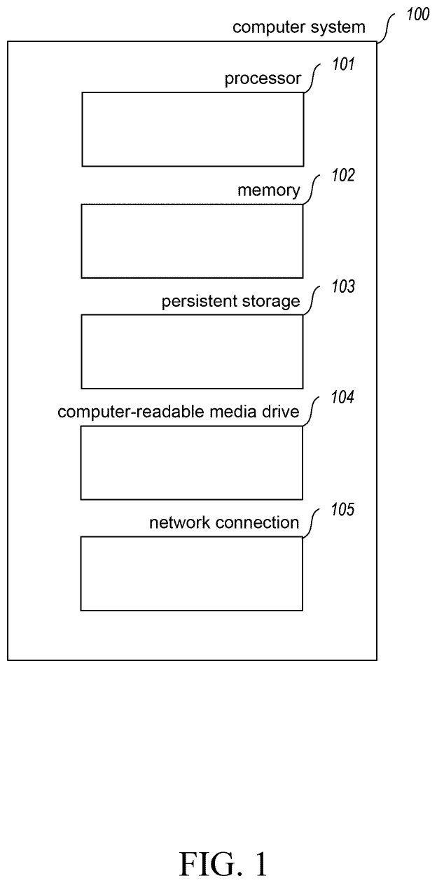

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

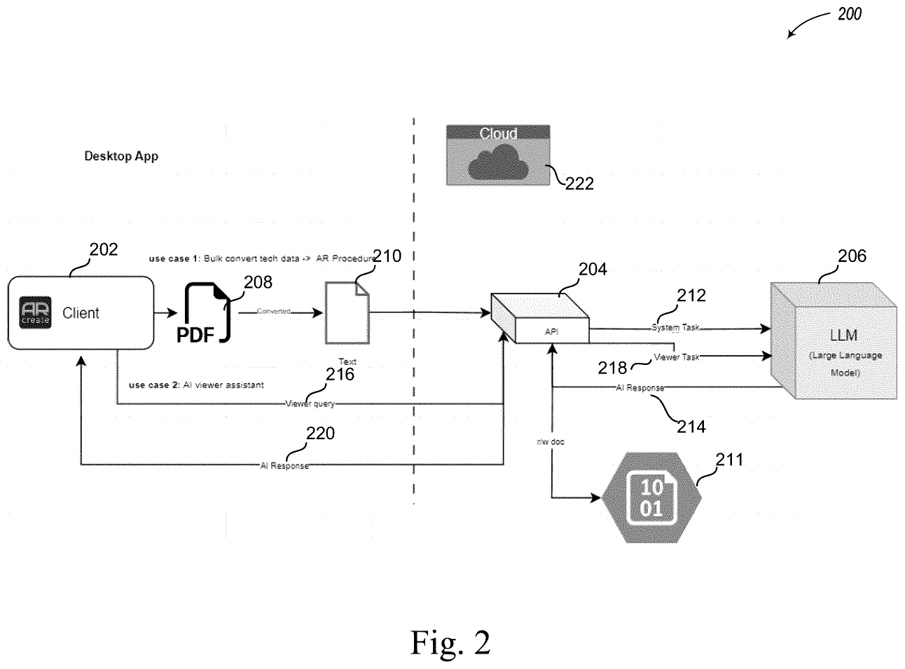

FIG. 2 is a data flow diagram 200 that describes data exchange in accordance with the facility in some embodiments. The facility includes client 202, application programming interface (API) 204, and generative artificial intelligence model 206.

Client 202 provides unstructured data 208 including instructional content to be used in generating structured data for use in mixed reality applications. In various embodiments, unstructured data 208 contains images, videos, or other content. Unstructured data 208 is transformed to unstructured text 210, which is a textual representation of unstructured data 208. The transformation is performed using parsing, image analysis, or other data extraction techniques. In some embodiments, unstructured text 210 is a natural language representation of unstructured data 208.

API 204 obtains unstructured text 210 and establishes a system task prompt 212 to provide to generative artificial intelligence model (model) 206. In some embodiments, API 204 stores unstructured data 208, unstructured text 210, or both, as stored data 211. System task prompt 212 includes one or more commands for the generative artificial intelligence model to follow in converting unstructured text 210 into structured data. The one or more commands include defining a schema for the structured data to follow. Table 1 below is an example of commands provided to the model in system task prompt 212 in addition to unstructured text 210.

```
TABLE 1
Return the list of steps of the provided instructional text as individual
procedures segmented logically. Follow any custom instructions from
user carefully prior to generating the procedures. Respond in a JSON
the format to the user with the following format
{
  ″procedures″:[
    {
      ″procedure_name″:″the name of the process should go here″
        ″summary″:summarize the process here in less than 100 words
        ″instructions″:[
        {
          ″number″:″put the number of the step here″
          ″instruction″:″put the step instruction here″
  ″image_file″:″put the full path of the image file here if one exists in the
text″, extensions include .jpg″,
          ″.png″,
          ″etc.″
        }
      ]
    }
```

Generative artificial intelligence model (model) 206 obtains system task prompt 212 and generates proposed structured data 214. In the example illustrated in Table 1 and Table 2, the proposed structured data is formatted as a JavaScript Object Notation (JSON) file. In various embodiments, the system task prompt specifies any suitable format for the proposed structured data.

API 204 receives proposed structured data 214. Proposed structured data 214 is structured according to the schema defined by the one or more commands in system task prompt 212. Table 2 below is an example excerpt of proposed structured data generated using the example commands in Table 1.

```
TABLE 2
″message″:{
    ″role″:″assistant″,
″content″:″{\n \″procedures\″: [\n {\n \″procedure_name\″: \″Lower Plate
Assembly - Part 1\″,\n \″summary\″: \″This procedure involves assembling the
lower plate of the National UAS Training and Certification Center.\″,\n
\″instructions\″: [\n {\n \″number\″: 1,\n \″instruction\″: \″Install a large
grommet on each arm of the lower assembly plate (×4).\″,\n \″image_file\″:
\″C:/Users/UserName/AppData/LocalLow/simplear/ARcreate//Lower Plate
Assembly.pdf//images//image_3_1.png\″\n },\n {\n \″number\″: 2,\n
\″instruction\″: \″Install 4 small grommets on the body of the lower assembly
plate.\″,\n \″image_file\″:
\″C:/Users/UserName/AppData/LocalLow/simplear/ARcreate//Lower Plate
Assembly.pdf//images//image_4_1.png\″\n },\n {\n \″number\″: 3,\n
\″instruction\″: \″Align battery adaptors to lower assembly holes.\″, \n
\″image_file\″: \″C:/Users/UserName/AppData/LocalLow/simplear/ARcreate//Lower
Plate Assembly.pdf//images//image_5_1.png\″\n },\n {\n \″number\″:
4,\n \″instruction\″: \″Secure battery adapters to the underside of the bottom
assembly using 4 socket cap screws each; tighten with TorxT10 tool.\″,\n
\″image_file\″: \″C:/Users/UserName/AppData/LocalLow/simplear/ARcreate//Lower
Plate Assembly.pdf//images//image_6_1.png\″\n },\n {\n
  }
```

In some embodiments, API 204 validates proposed structured data 214 by parsing it into the schema defined by the one or more commands in system task prompt 210 to ensure it follows the defined schema. The structured data is in some embodiments usable to present a mixed reality experience to a viewer.

The viewer may also use client 202 to query model 206 about the mixed reality experience. Viewer query 216 is provided to API 204, which creates a viewer prompt 218 based on viewer query 216. Viewer prompt 218 in some embodiments include information from stored data 211. In some embodiments, viewer prompt 218 includes additional commands. The additional commands included in viewer prompt 218 are in various embodiments determined based on a portion of the mixed reality experience the viewer is viewing, an action of the viewer, a feature of the physical environment, etc.

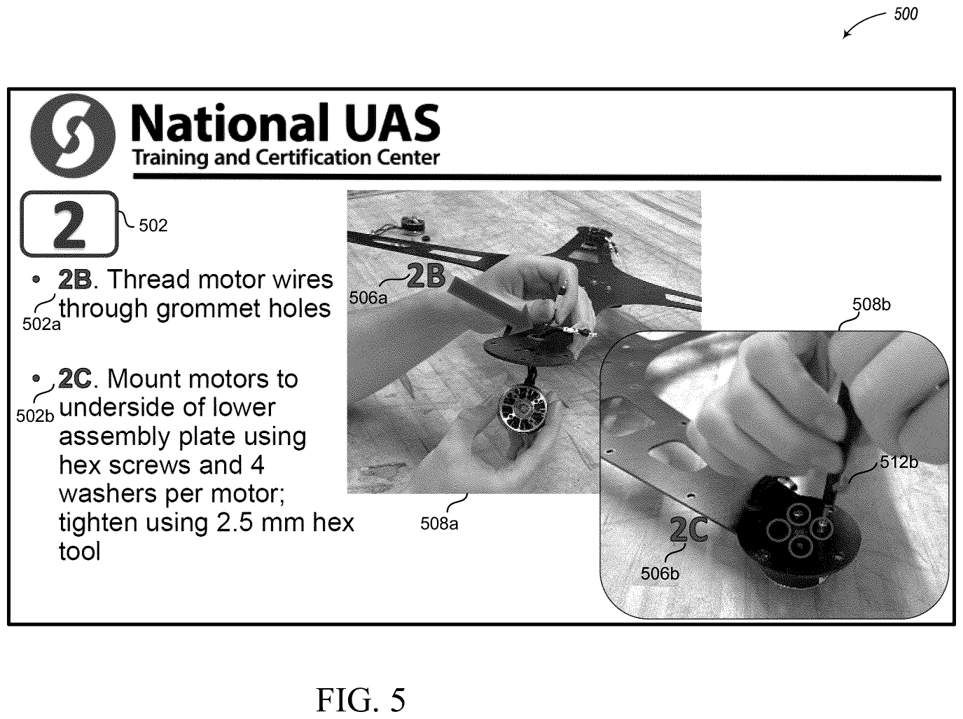

The viewer may query the facility for information regarding the step in the mixed reality experience they are performing. Referring to FIG. 5, the viewer is in this example viewing a step in a mixed reality experience corresponding to step 502b, wherein they are being prompted to mount motors to an assembly plate. A viewer query for the mixed reality experience corresponding to step 502b may be: “where do I put the washers?” In creating viewer prompt 218, the facility in various embodiments includes some or all of stored data 211 in viewer prompt 218, along with additional commands. In some embodiments, the one or more commands include commands for model 206 to follow in generating the viewer response. The facility in some embodiments specifies that viewer responses should be “concise,” “clear,” “based on the stored data provided below,” “in English,” “in Portuguese,” etc. In some embodiments, the one or more commands define another schema for the response to follow. It is desirable in some embodiments to present a response to the viewer by a virtual artifact in the mixed reality experience. For example, in some embodiments the one or more commands define a schema usable in the mixed reality experience for the response to follow and further specify to “generate a command to highlight the object the viewer is asking about in the mixed reality experience.” In this example, model 206 is being commanded to generate a response that is usable to highlight the washers in the mixed reality experience. In some embodiments, the one or more commands are natural language text.

Viewer prompt 218 is provided to model 206, which processes the viewer prompt to produce a response 214, which is processed by the facility into viewer query response 216. In various embodiments, viewer query response 216 is provided to the viewer as speech using text-to-speech, as a virtual artifact in the mixed reality experience, etc.

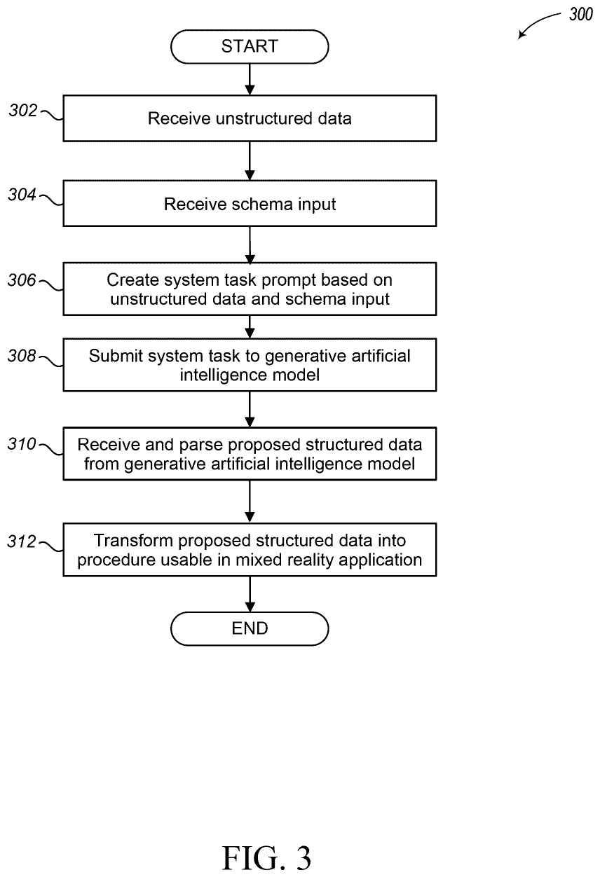

FIG. 3 is a flow diagram showing a process 300 used by the facility in some embodiments to generate structured data for use in mixed reality applications.

After a start block, process 300 begins at block 302, where the facility receives unstructured data. The unstructured data is in various embodiments a portable document format (PDF), text document, image, video, or any other media or multimedia format.

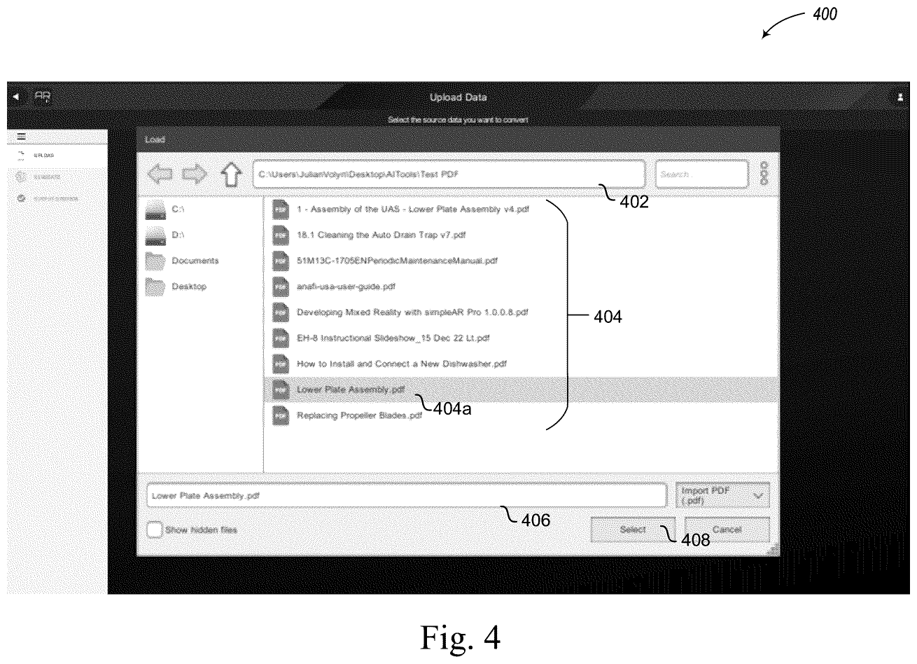

FIG. 4 is a display diagram illustrating an interface 400 used by the facility in some embodiments to receive unstructured data including instructional content. In the example shown in FIG. 4, a user navigates to directory path 402 to view unstructured data files 404. The user then selects an unstructured data file among unstructured data files 404, such as unstructured data file 404a. The name of the selected unstructured data file is displayed in selection field 406. The user then confirms the selection with select button 408.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

FIG. 5 is a document diagram showing an example excerpt of unstructured instructional content (content) 500 accessed by the facility in some embodiments. In this example, content 500 includes step 502. Step 502 includes sub-steps 502a and 502b, and their descriptive text. Content 500 also includes graphics 508a and 508b, corresponding to sub-steps 502a and 502b, respectively. Graphics 508a and 508b include indicators 506a and 506b, respectively. Graphic 508b also includes action indicator 512b. The specific content present in an unstructured document may vary and may include video, graphics, text, audio, etc.

Returning to FIG. 3, after block 302, process 300 continues to block 304, where the facility receives schema input. In some embodiments, the schema input is similar or identical to the example commands shown in Table 1.

In block 306, the facility creates a system task prompt based on the unstructured data and the schema input. The unstructured data is converted to a text format such as plain text before being used to create the system task prompt. As discussed herein, this conversion is performed using any known data extraction technique. In various embodiments where the unstructured data is in a multimedia format, conversion includes applying voice-to-text to audio content, summarization of content by a generative artificial intelligence model, etc. In some embodiments, the system task prompt is created by concatenating the unstructured data with the schema input. The system task prompt in some embodiments includes additional commands for the generative artificial intelligence model to follow, such as “carefully follow the instructions to create the structured data.” In some embodiments, the facility stores one or more commands to be followed by the model in creating the prompt. For example, an example stored command specifies certain steps, language, etc., that must be included in the structured data.

In some embodiments, a predetermined command specifies a “temperature” parameter for the model indicating the desired randomness of the model's output. In various embodiments, it is desirable to change the temperature of the model used in generating the response. The temperature is in various embodiments based on the presence of keywords in, the tone of, the subject matter of, etc. the unstructured data. The facility in some embodiments requests the model to lower its temperature to account for a higher perceived risk present in one or more steps in the procedure. For example, when certain keywords such as “hazard,” “care,” “danger,” etc. are present in a step, the perceived risk of the step is higher. In various embodiments, the model may be prompted to set its own temperature parameter based on a tone, subject matter, content, etc. of the unstructured data.

After block 306, process 300 continues to block 308 where the facility submits the system task to a generative artificial intelligence model. In various embodiments, the generative artificial intelligence model is cohosted with the facility or hosted remotely and accessed via an application programming interface.

After block 308, process 300 continues to block 310 where the facility receives and parses proposed structured data received from the generative artificial intelligence model. According to some embodiments, the proposed structured data is validated by parsing it into the format defined by the schema input. For example, the schema defined in Table 1 includes one or more “procedure” objects, with each procedure object including the fields “procedure_name,” “summary,” and one or more “instructions,” each including a “number,” “instruction,” and “image_file” field. Therefore, the proposed structured data may be parsed for data corresponding to each of these fields. In some embodiments, parsing succeeds when valid data corresponding to each of the fields in the schema is obtained.

In some embodiments, parsing fails because data corresponding to a field was missing, malformed, included an incompatible or incorrect value, etc. For example, a file path corresponding to the “image_file” field may be invalid. In some embodiments where parsing fails, the facility solicits a new selection of an unstructured data file to generate a new system task prompt. In various embodiments, block 310 employs embodiments of FIG. 4 to receive a new selection of an unstructured file. In various embodiments where parsing fails, the facility may solicit other modifications to the system task prompt, such as modifying one or more commands. Then, process 300 begins again at block 302 using the modified input.

After block 310, process 300 continues to block 312 where the facility transforms the proposed data structure into a procedure usable in a mixed reality application. In some embodiments, the facility transforms the proposed structured data into the procedure using a predetermined mapping between the proposed data structure and the procedure. In some embodiments, process 300 may skip (not shown) the parsing step in block 310 and skip block 312, accepting the response from the generative artificial intelligence model as the procedure usable in the mixed reality application, and ending process 300. In at least these embodiments, the schema input defines a schema for the procedure. After block 312, process 300 ends.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

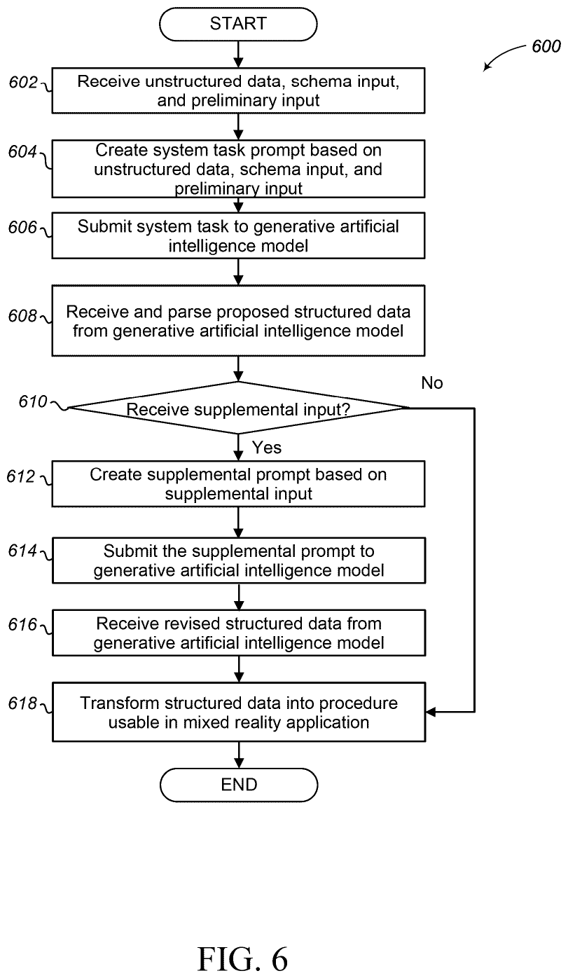

FIG. 6 is a flow diagram showing a process 600 performed by the facility in some embodiments to generate structured data in response to a submitted system prompt including preliminary input and supplemental input.

Process 600 begins, after a start block, at block 602 where the facility receives unstructured data, schema input, and preliminary input. In some embodiments, no preliminary input is received.

After block 602, process 600 continues to block 604 where the facility creates a system task prompt based on the unstructured data, schema input, and preliminary input. In some embodiments, the facility creates the system task prompt by concatenating a text version of the unstructured data, the schema input, and the preliminary input. In various embodiments, block 604 employs embodiments similar to those of block 306 in FIG. 3 to create the system task prompt.

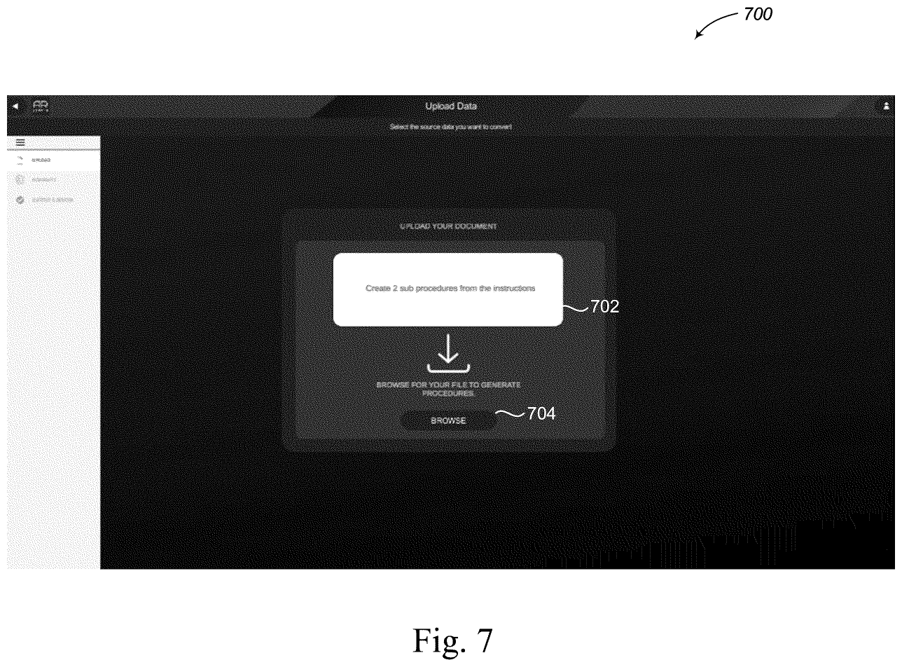

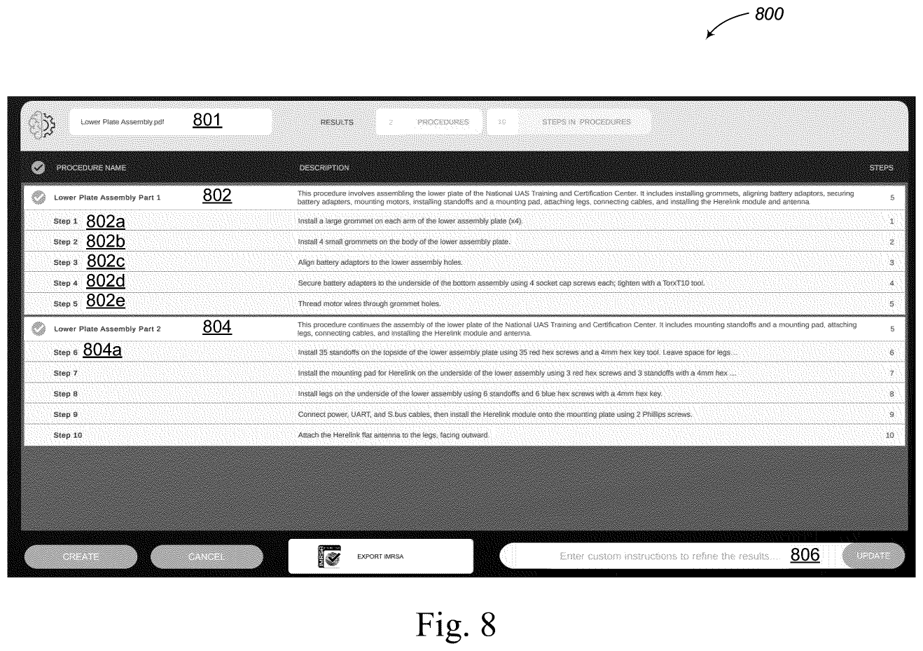

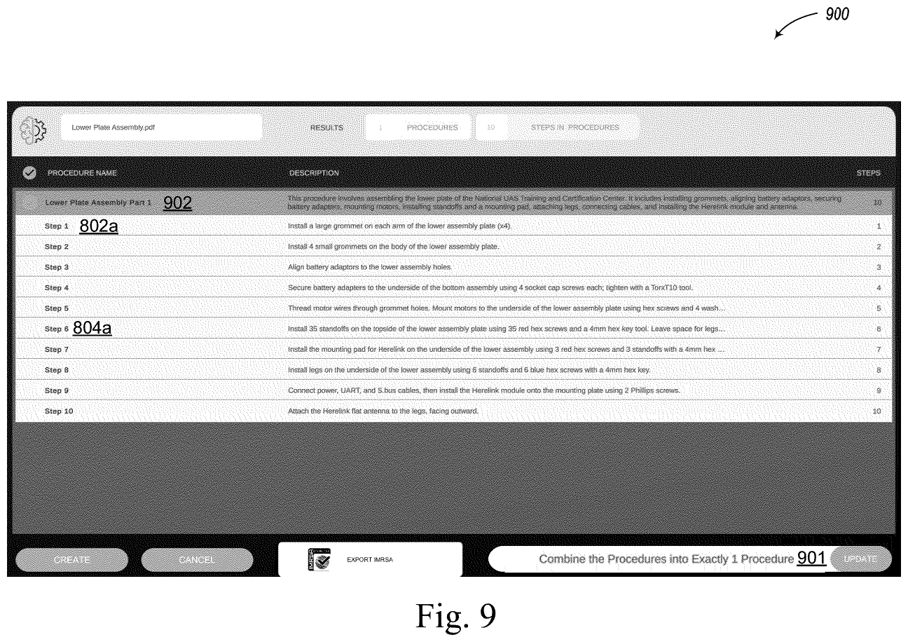

FIG. 7 is a display diagram illustrating an interface 700 used by the facility in some embodiments to receive one or more preliminary commands. Input field 702 allows an operator to provide one or more preliminary commands. According to the example shown in FIG. 7, the preliminary command is “Create 2 sub procedures from the instructions.” The resulting proposed structured data generated using these commands is shown in FIG. 8, wherein the procedure includes two sub-procedures 802 and 804. FIG. 9 shows an example of proposed structured data generated where this preliminary command was not provided.

Returning to FIG. 6, after block 604, process 600 continues to block 606, where the facility submits the system task prompt to the generative artificial intelligence model (model).

After block 606, process 600 continues to block 608, where the facility receives and parses proposed structured data received from the model. In various embodiments, block 608 employs embodiments of block 310 in FIG. 3 to parse the proposed data structure.

After block 608, process 600 continues to decision block 610, where the facility determines whether supplemental input was received.

If no supplemental input was received, process 600 continues to block 618. If supplemental input was received, process 600 continues to block 612, where the facility creates a supplemental prompt based on the supplemental input. In some embodiments, the supplemental prompt is created by concatenating the supplemental input and the proposed structured data. In various embodiments, block 612 employs embodiments of block 306 in FIG. 3 to create the supplemental prompt. The facility in some embodiments modifies the supplemental prompt to include additional predetermined commands limiting the scope of modifications to be made to the proposed data structure. For example, in some embodiments the facility modifies the supplemental prompt to include a command requesting the generative artificial intelligence model to maintain one or more features of the unstructured data such as a sequence of steps.

After block 612, process 600 continues to block 614, where the facility submits the supplemental prompt to the model. The model may be cohosted with the facility or remotely hosted on a server, for example, in cloud 222 in FIG. 2.

After block 614, process 600 continues to block 616, where the facility receives revised structured data from the generative artificial intelligence model. In some embodiments, the revised structured data is again parsed (not shown) employing embodiments of block 608 to verify its compliance with the schema input.

FIG. 8 is a display diagram illustrating an interface 800 used by the facility in some embodiments to display proposed structured data generated by a large language model in response to a submitted system prompt including one or more preliminary commands. Source field 801 displays the unstructured data file used to generate the depicted procedure. Sub-procedure 802 includes a plurality of steps including steps 802a, 802b, 802c, 802d, and 802e (steps 802a-e). Sub-procedure 804 includes step 804a. Supplemental input field 806 is in some embodiments used to enter supplemental input to refine the procedure. In various embodiments, the proposed structured data contains any number of steps divided into any number of sub-procedures. In some embodiments, the number of steps in a first sub-procedure is different from the number of steps in a second sub-procedure.

Returning to FIG. 6, process 600 continues after block 616 to block 618, where the facility transforms the structured data into a procedure usable in a mixed reality application. The “structured data” in block 618 refers to the proposed structured data in some embodiments where it is determined at block 610 that no supplemental input was received and refers in some embodiments to the revised structured data where it is determined at block 610 that supplemental input was received. In various embodiments, block 616 employs embodiments of block 312 in FIG. 3 to transform the structured data into a procedure usable in a mixed reality application.

FIG. 9 is a display diagram illustrating an interface 900 used by the facility in some embodiments to display updated proposed structured data generated by a large language model using proposed structured data and supplemental commands. Supplemental command 901 is a command the model was to follow in generating updated proposed structured data. In the example shown in FIG. 9, the supplemental command is “Combine the Procedures into Exactly 1 Procedure.” The example procedure in FIG. 9 was generated by applying supplemental command 901 to the procedure shown in FIG. 8. That is, the model has already modified the procedure shown in FIG. 9 to reflect supplemental command 901. Accordingly, sub-procedure 802 and sub-procedure 804 of FIG. 8 appear combined into one procedure 902 in FIG. 9. Step 802a, the first step of sub-procedure 802 in FIG. 8, is the first step 802a in procedure 902. Step 804a, once the first step of sub-procedure 804, is now also incorporated into procedure 902. While supplemental command 901 is an example requesting to combine two sub-procedures into one procedure, the disclosure is not so limited. Supplemental command 901 may command the model to remove, add, or modify one or more steps in a procedure, modify the phrasing, tone, or content of one or more steps in the procedure, translate the procedure into a different language, reverse the steps of the procedure, etc. In general, supplemental command 902 may define any operation for the model to perform on the procedure.

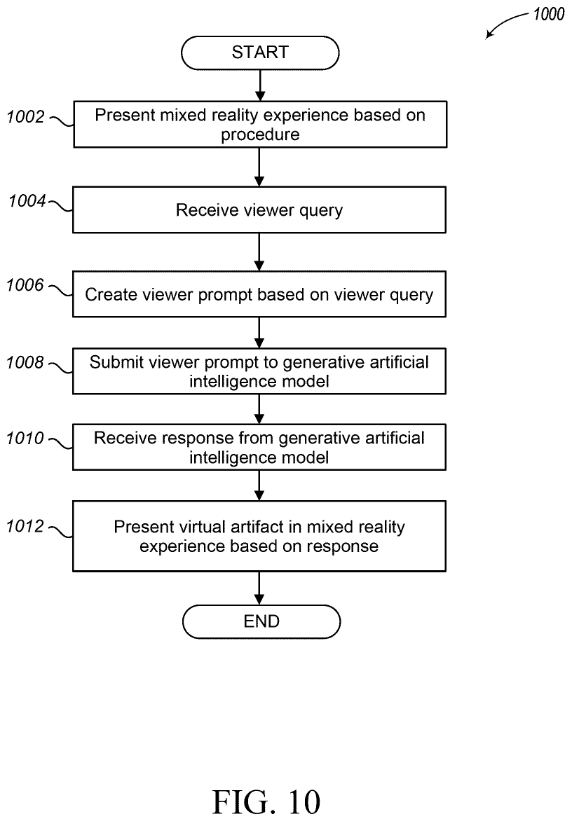

FIG. 10 is a flow diagram showing a process 1000 performed by the facility in some embodiments to respond to a viewer query based on generated structured data.

After a start block, process 1000 begins at block 1002, where the facility presents a mixed reality experience based on a procedure. In some embodiments, the facility creates the procedure using embodiments of process 600 of FIG. 6. The mixed reality experience (the experience) in some embodiments solicits performance by a viewer of an ordered sequence of steps in accordance with the procedure. Returning to FIG. 9, an example mixed reality experience includes the facility soliciting the viewer to “install a large grommet on each arm of the lower assembly plate (×4)” in accordance with step 802a. In various embodiments, the facility solicits performance of a step using text-to-speech applied to text of the step such that the viewer hears the text of the step. In some embodiments, the facility moves the experience to the next step in the sequence when the viewer indicates they have completed a step. In some embodiments, the experience automatically moves to the next step when the facility detects the viewer has completed the step.

In various embodiments, the facility solicits performance of a step in a procedure by displaying content associated with the step. The content in some embodiments includes one or more graphics associated with the step. Referring to FIG. 5, for example, graphic 508a is associated with step 502a. Therefore, graphic 508a is in some embodiments displayed using one or more virtual artifacts in the mixed reality experience during a step in the experience corresponding to step 502a. For example, an artifact including graphic 508a appears in some embodiments to float in a position in front of the viewer in the experience. In some embodiments, the facility displays the one or more virtual artifacts in the experience such that the viewer simultaneously views the one or more virtual artifacts and the subject matter of the step in the physical world. For example, when the viewer is physically manipulating a lower assembly on a table as depicted in graphic 508a, graphic 508a is in some embodiments displayed using a virtual artifact in the experience such that it appears on the table next to the lower assembly.

In some embodiments, the facility moves a virtual artifact with the viewer's field of view in the experience, such that the viewer sees the artifact regardless of where they are looking in the experience. In some embodiments, the facility displays a virtual artifact at a selected physical location in the experience, such as on a table, so the viewer only sees the virtual artifact when their field of view includes the selected physical location.

In various embodiments, the facility solicits performance of a step in the procedure by displaying a virtual action artifact corresponding to the step. Referring again to FIG. 5, graphic 508b includes action indicator 512b, which highlights objects involved in performing the step and indicates an action required to perform the step. For example, action indicator 512b indicates that four screws must be screwed in clockwise. The facility in this example displays action indicator 512b in the experience as a virtual action artifact. In some embodiments, the virtual action artifact is displayed at a selected physical location, such as the lower assembly depicted in graphic 508b.

After block 1002, process 1000 continues to block 1004, where the facility receives a viewer query. In some embodiments, the facility automatically constructs viewer queries using information collected from the physical environment. The facility in some embodiments receive a video feed from a virtual reality headset worn by the viewer and automatically constructs a viewer query based on the video feed. The facility in some embodiments receives a data stream containing information used to display the mixed reality experience to the viewer. The viewer query in some embodiments includes a command specifying that the response from the model should be formatted to be used as a virtual artifact in the mixed reality experience.

In some embodiments, the viewer query is based on an explicit query provided by the viewer. The viewer in some embodiments provides a verbal query requesting information regarding the mixed reality experience. For example, the viewer asks “how many screws do I need for this step?” The viewer query is then created using speech-to-text on the verbal query. In some embodiments, the viewer may select a viewer query from a plurality of viewer queries displayed in the mixed reality experience. The facility in some embodiments predetermines the plurality of viewer queries for one or more steps in the experience based on other viewers' performance of the one or more steps. In some embodiments, the facility dynamically generates the plurality of viewer queries based on the viewer's performance of the one or more steps.

In some embodiments, the viewer query is based on action or inaction of the viewer. For example, if the viewer is having difficulty performing a step in the experience, the facility in this example automatically sends a viewer query commanding the model to generate a response rephrasing instructions associated with the step. In some embodiments, the facility determines that the viewer is having difficulty completing a step if a threshold time limit such as 30 seconds, one minute, five minutes, etc., is exceeded during the viewer's performance of the step.

In some embodiments, the viewer query is contextual. The viewer query in some embodiments correspond to a feature of the physical environment. For example, the facility detects by a video feed from a camera of a virtual reality headset worn by the viewer that the viewer is holding an assembly upside-down based on a comparison with an image associated with the step such as graphic 308b in FIG. 3. Then, the facility automatically sends a viewer query requesting for clarification about how to hold the assembly.

After block 1004, process 1000 continues to block 1006, where the facility creates a viewer prompt based on the viewer query. In various embodiments, block 1006 may employ embodiments of block 506 to create the viewer prompt.

After block 1006, process 1000 continues to block 1008, where the facility submits the viewer prompt to a generative artificial intelligence model.

After block 1008, process 1000 continues to block 1010, where the facility receives a response from the generative artificial intelligence model. In some embodiments, the facility uses the response to display a virtual artifact in the mixed reality experience.

After block 1010, process 1000 continues to block 1012, where the facility presents a virtual artifact in the mixed reality experience based on the response. As discussed herein, the virtual artifact is in some embodiments a graphic associated with the step in the mixed reality experience. The virtual artifact is, in some embodiments, a graphic containing text of the response. In various embodiments, the facility displays virtual artifact proximate a physical object in the mixed reality experience, or so that the viewer sees the virtual object regardless of where the viewer is looking in the experience. After block 1012, process 1000 ends at an end block.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed in a computing system for generating structured data for use in mixed reality applications, the method comprising:
receiving unstructured data including instructional content;
receiving schema input specifying a first schema to which the unstructured data is to conform;
establishing a system task prompt based on the unstructured instructional content and the schema input;
submitting the system task prompt to a large language model (LLM);
receiving proposed structured data from the LLM;
parsing the proposed structured data into structured data according to the first schema; and
transforming the structured data into a procedure usable in a mixed reality application.

2. The method of claim 1 wherein creating the system task prompt comprises:
receiving preliminary input specifying a command to be followed by the LLM in generating the proposed structured data; and
creating the system task prompt based on the preliminary input.

3. The method of claim 1, further comprising:
receiving supplemental input specifying a command to be followed by the LLM in revising the structured data;
creating a supplemental prompt based on the supplemental input;
submitting the supplemental prompt to the LLM; and
receiving revised structured data from the LLM.

4. The method of claim 1, further comprising:
presenting to a viewer a mixed reality experience based on the procedure;
receiving from the viewer a query regarding the mixed reality experience;
creating a viewer prompt based on the query and the procedure;
submitting the viewer prompt to the LLM;
receiving, from the LLM, a response based on the viewer prompt; and
presenting to the viewer, by the mixed reality experience, a virtual artifact based on the response.

5. The method of claim 1, further comprising:
presenting to a viewer a mixed reality experience based on the procedure.

6. The method of claim 1, further comprising:
receiving input specifying one or more steps in the structured data to include in the procedure; and
including the specified one or more steps in the procedure.

7. The method of claim 1, further comprising:
detecting an error in the parsing;
receiving correction input specifying a correction to the system task prompt;
creating a corrected prompt based on the system task prompt and the correction input;
submitting the corrected prompt to the LLM; and
receiving, from the LLM, a response based on the corrected prompt.

8. A system for generating structured data for use in mixed reality applications, the system comprising:
one or more memories configured to collectively store computer instructions; and
one or more processors configured to collectively execute the stored computer instructions to:
receive unstructured data including instructional content;
establish a schema to which the unstructured data is to conform;
establish a system task prompt based on the unstructured instructional content and the schema;
submit the system task prompt to a large language model (LLM);
receive structured data from the LLM; and
construct, using the structured data, a procedure usable in a mixed reality application.

9. The system of claim 8, wherein the one or more processors are further configured to:
receive preliminary input specifying a command to be followed by the LLM in generating the structured data; and
create the system task prompt based on the preliminary input.

10. The system of claim 8, wherein the one or more processors are further configured to:
receive supplemental input specifying a command to be followed by the LLM in revising the structured data;
create a supplemental prompt based on the supplemental input;
submit the supplemental prompt to the LLM; and
receive revised structured data from the LLM.

11. The system of claim 8, wherein the one or more processors are further configured to:
present to a viewer a mixed reality experience based on the procedure;
receive from the viewer a query regarding the mixed reality experience;
create a viewer prompt based on the query and the procedure;
submit the viewer prompt to the LLM;
receive, from the LLM, a response based on the viewer prompt; and
present to the viewer, by the mixed reality experience, a virtual artifact based on the response.

12. The system of claim 8, wherein the one or more processors are further configured to:
present to a viewer a mixed reality experience based on the procedure.

13. The system of claim 8, wherein the one or more processors are further configured to:
receive input specifying one or more steps in the structured data to include in the procedure; and
include the specified one or more steps in the procedure.

14. The system of claim 8, wherein the one or more processors are further configured to:
present to a viewer a mixed reality experience based on the procedure;
receive contextual data corresponding to a feature of a physical environment while the one or more processors present the mixed reality experience;
create a contextual prompt based on the contextual data and the procedure;
submit the contextual prompt to the LLM;
receive, from the LLM, a response based on the contextual prompt; and
present to the viewer, by the mixed reality experience, a virtual artifact based on the response.

15. One or more memories collectively storing instructions that, when executed by one or more processors in a computing system, cause the one or more processors to perform a method, the method comprising:
receiving unstructured data including instructional content;
establishing a schema to which the unstructured data is to conform;
establishing a system task prompt based on the unstructured instructional content and the schema;
submitting the system task prompt to a generative artificial intelligence model;
receiving structured data from the generative artificial intelligence model; and
constructing, using the structured data, a procedure usable in a mixed reality application.

16. The one or more memories of claim 15, the method further comprising:
receiving preliminary input specifying a command to be followed by the generative artificial intelligence model in generating the proposed structured data; and
creating a system task prompt based on the preliminary input.

17. The one or more memories of claim 15, the method further comprising:
receiving supplemental input specifying a command to be followed by the generative artificial intelligence model in revising the structured data;
creating a supplemental prompt based on the supplemental input;
submitting the supplemental prompt to the generative artificial intelligence model; and
receiving revised structured data from the generative artificial intelligence model.

18. The one or more memories of claim 15, the method further comprising:
presenting to a viewer a mixed reality experience based on the procedure;
receiving a query regarding the mixed reality experience from the viewer;
creating a viewer prompt based on the query and the procedure;
submitting the viewer prompt to the generative artificial intelligence model;
receiving, from the generative artificial intelligence model, a response based on the viewer prompt; and
presenting to the viewer, by the mixed reality experience, a virtual artifact based on the response.

19. The one or more memories of claim 15, the method further comprising:
presenting a step in a mixed reality experience based on a step in the procedure;
selecting content in a portion of the unstructured data corresponding to the step in the procedure; and
presenting to the viewer, by the mixed reality experience, a virtual artifact based on the selected content.

20. The one or more memories of claim 15, the method further comprising:
presenting to a viewer a mixed reality experience based on the procedure;
receiving contextual data corresponding to an action taken by the viewer while the one or more processors are presenting the mixed reality experience;
creating a contextual prompt based on the contextual data and the procedure;
submitting the contextual prompt to the generative artificial intelligence model;
receiving, from the generative artificial intelligence model, a response based on the contextual prompt; and
presenting to the viewer, by the mixed reality experience, a virtual artifact based on the response.
